(19) United States
(12) Patent Application Publication
(10) Pub. No.: US 2018/0202870 A1
(43) Pub. Date: Jul. 19, 2018

(54) TEMPERATURE MONITORING SYSTEM

(71) Applicant: James Esposito, Margate, FL (US)

(72) Inventor: James Esposito, Margate, FL (US)

(21) Appl. No.: 15/852,140

(22) Filed: Dec. 22, 2017

Related U.S. Application Data
(60) Provisional application No. 62/446,348, filed on Jan. 13, 2017.

(51) Int. Cl. G01K 13/00

(52) U.S. Cl. CPC G01K 13/00; G01K 2207/02

(57) ABSTRACT

A temperature monitoring system includes an outer casing, a plurality of display elements, a plurality of buttons, a visual indicator, and a temperature sensing element. The temperature sensing element may be coupled to the outer casing and configured to sense a temperature inside a food supply unit. The temperature monitoring system continuously monitors the temperature inside of the food supply unit such as a refrigerator or steam table.

### CROSS REFERENCE TO RELATED APPLICATION

The present application is related to and claims priority to U.S. Provisional Patent Application No. 62/446,348 filed Jan. 13, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of temperature monitors and more specifically relates to a refrigerator or steam table temperature alert.

### 2. Description of Related Art

Food safety is a scientific discipline describing handling, preparation, and storage of food in ways that prevent food-borne illness. Food can transmit disease from person to person as well as serve as a growth medium for bacteria that can cause food poisoning. It is important to maintain proper temperature to avoid bacteria growth. A food thermometer is used to measure temperature ensuring that the food is safe to eat. Temperature level is extremely important when it comes to storing food. If a refrigerator, steam table, or freezer becomes too warm, food will spoil and need to be thrown away. If a steam table doesn't hold its temperature, bacteria can begin to grow and cause foodborne illness. Restaurants can receive poor scores from health inspectors and be forced to shut down if temperatures are incorrect. It is extremely difficult for restaurants and warehouses to manually keep track of all freezer/refrigerator/steam table temperatures. A suitable solution is desired.

U.S. Pub. No. 2010/0283573 to Kwanho YUM, et. al. relates to a mobile terminal, operating method thereof, and refrigerator. The described mobile terminal, operating method thereof, and refrigerator includes a mobile terminal, an operating method thereof, and a refrigerator. The operating method of the mobile terminal includes receiving state information of the refrigerator from the refrigerator, displaying the state information of the refrigerator on a screen, and transmitting a control signal based on a control operation to the refrigerator. Therefore, it is possible to readily control the refrigerator using the mobile terminal.

### BRIEF SUMMARY OF THE INVENTION

In view of the foregoing disadvantages inherent in the known temperature monitor art, the present disclosure provides a novel temperature monitoring system. The general purpose of the present disclosure, which will be described subsequently in greater detail, is to provide a temperature monitoring system configured to continuously monitor a temperature inside of a food supply unit.

A temperature monitoring system for continuously monitoring a temperature inside a food supply unit is disclosed herein; the temperature monitoring system comprising: an outer casing, a plurality of display elements, a plurality of buttons, a visual indicator, and a temperature sensing element. The outer casing having an elongate body with a front side and a back side. The plurality of display elements may be located on the front side of the outer casing. The plurality of buttons are located on the front side of the outer casing and configured to allow manual control of the temperature monitoring system. The visual indicator is preferably located on an outermost portion of the front side of the outer casing and configured to communicate information to a user. The temperature sensing element may be coupled to the outer casing and configured to sense a temperature inside a food supply unit. The temperature monitoring system is configured to continuously monitor the temperature inside of the food supply unit.

The plurality of display elements may include two digital numerical displays. One of the two digital numerical displays may provide a first-measurement of a first-temperature. A second of the two digital numerical displays may include a status of a battery of the temperature monitoring system. The first-temperature includes a current-temperature of the food supply unit. The temperature monitoring system is configured to send an alert to the user when a current temperature of the food supply unit falls below the predetermined alert temperature. The temperature monitoring system is configured to send an alert to the user when the current temperature of the food supply unit rises above the predetermined alert temperature. The temperature monitoring system further comprising a clip for attaching the temperature monitoring system to an outside of the food supply unit. The alert is a digital communication. The visual indicator is configured to indicate a Wi-Fi connection. The plurality of buttons includes a power indicator button, a temperature-up button, and a temperature-down button.

A method of using the temperature monitoring system for monitoring an internal temperature of a food supply unit is also disclosed herein. The method of using temperature monitoring system may comprise the steps of: plugging in the device and powering on, opening wireless internet connections on a smart device and searching for food temperature monitor, selecting the device for wireless internet (it will say no internet access), opening web browser to a new page and scanning for nearest wireless network, select the proper wireless network and inputting a password, the device will then refresh with the current temperature and battery health. The device is now ready for use and may be placed in a designated location. A mobile application may be downloaded on a smartphone and opened for use. The user then add device IDs, the name of which device is being monitored and set the alert temperature. The use may go into settings and select Fahrenheit or Celsius. Users are able to add alert emails as needed.

The app gives real time alerts to a smart phone. The mobile application of the present invention may be downloaded on as many devices as necessary. The device is designed to monitor the temperature of hot and cold units such as coolers, freezers, steam tables, food warmers, buffet tables, and other units.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a temperature monitoring system, constructed and operative according to the teachings of the present disclosure.

FIG. 1 is a perspective view of the temperature monitoring system during an ‘in-use’ condition, according to an embodiment of the disclosure.

FIG. 2 is a front perspective view of the temperature monitoring system of FIG. 1, according to an embodiment of the present disclosure.

FIG. 3 is a front view of the temperature monitoring system of FIG. 1, according to an embodiment of the present disclosure.

FIG. 4 is a flow diagram illustrating a method of use for temperature monitoring system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to temperature monitors and more particularly to a temperature monitoring system as used to improve a refrigerator or steam table temperature alert means.

Generally, the present invention provides users with a food safety temperature alert system, sending alerts when the temperature of a cooler, freezer, steam table, and the like, enters into dangerously low or high temperatures wherein bacteria may grow. This eliminates the worry of food going bad due to unsafe temperatures. It ensures health inspections are passed within restaurants, effectively maintaining the temperature of all freezers, refrigerators, steam tables, and the like. It sends an email or app alert (if the app is downloaded) as a form of communication to a specified person if a temperature threshold is exceeded. The present invention prevents serious illnesses while saving restaurants extensive amounts of money in operation costs should temperatures fall or rise to excessive thresholds.

Components may include a custom PCB add-on, 4.7/1%/0.1W resistor 0603, 910k/1%/0.1W resistor 0603, 3M/1%/0.1W resistor 0603, feather ESP8266 WiFi Board, TFT FeatherWing Display, 500 mAH LiPo Battery, DS18B20 waterproof temperature probe, 3D printed case, 3D printed cover, and magnetic tape.

Temperature monitoring system is a food service temperature alert which, when paired with a smartphone or tablet, can send an email or app alert (if the app is downloaded) as a form of communication to a specified person should a refrigerator, steam table, freezer, or other equipment fall below or rise above a specified temperature threshold. The device is comprised of a thermostat, attached outside of the refrigeration unit, via a clip or mounting bracket. Users can set the temperature of their freezer, cooler, and/or steam table and the sensor located on the thermostat ensures the temperature is maintained. If there is a significant temperature change, an email or app alert (if the app is downloaded) can be sent quickly, giving the user time to make repairs or move food before it needs to be thrown away. Temperature monitoring system can be used in homes, restaurants, warehouses, and much more.

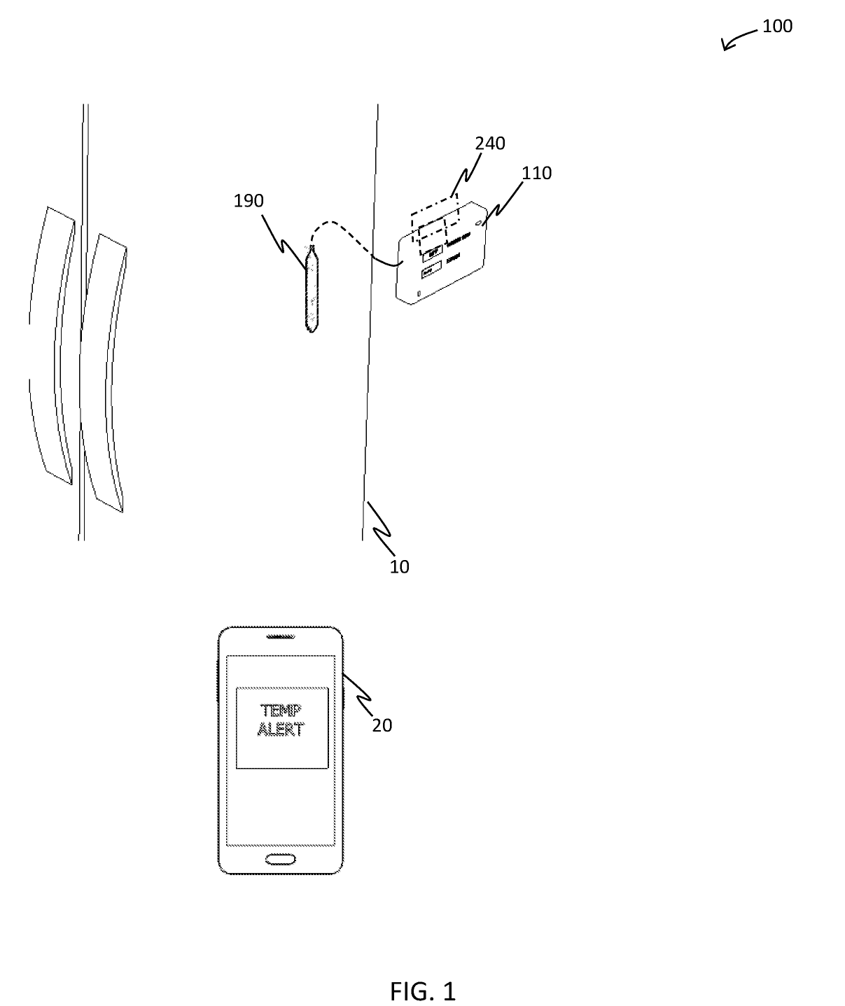

Referring now more specifically to the drawings by numerals of reference, there is shown in FIGS. 1-4, various views of a temperature monitoring system 100. FIG. 1 shows a temperature monitoring system 100 during an ‘in-use’ condition 150, according to an embodiment of the present disclosure. As illustrated, the temperature monitoring system 100 for continuously monitoring a temperature inside a food supply unit 10 includes an outer casing 110, a plurality of display elements 150, a plurality of buttons, a visual indicator 170, and a temperature sensing element 190. The outer casing 110 has an elongate body 120 with a front side 130 and a back side 140. The plurality of display elements 150 are located on the front side 130 of the outer casing 110. The plurality of buttons are located on the front side 130 of the outer casing 110 and are configured to allow manual control of the temperature monitoring system 100. The visual indicator 170 is located on an outermost portion 180 of the front side 130 of the outer casing 110 and is configured to communicate information to a user. The temperature sensing element 190 may be coupled to the outer casing 110 and configured to sense a temperature inside a food supply unit 10. The temperature monitoring system 100 is configured to continuously monitor the temperature inside of the food supply unit 10.

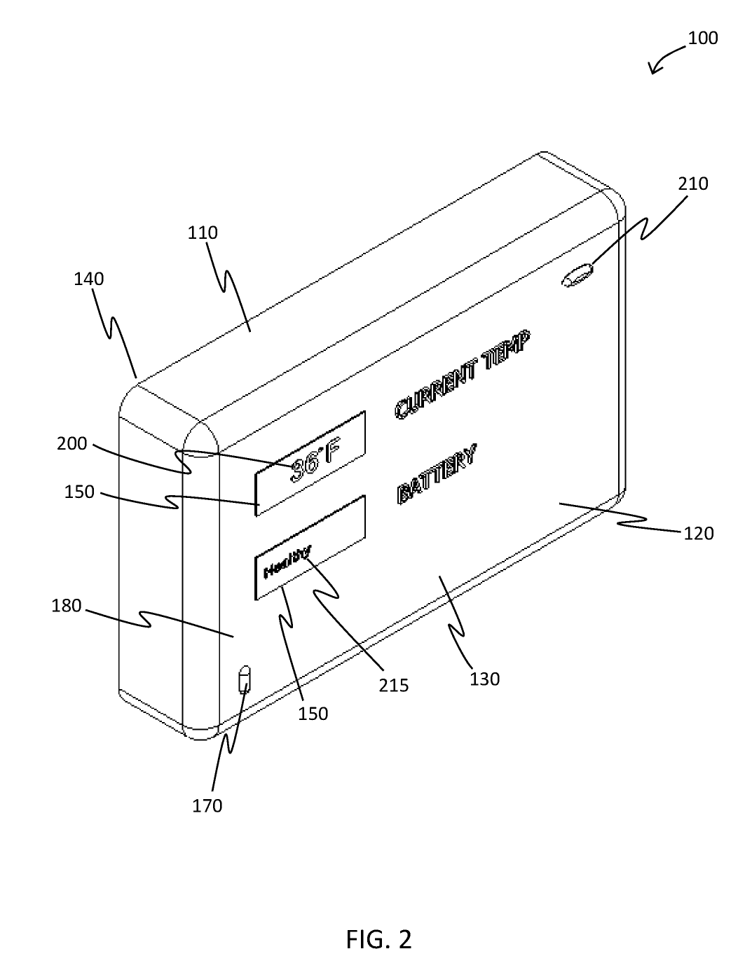

FIG. 2 shows a front perspective view of the temperature monitoring system 100 of FIG. 1, according to an embodiment of the present disclosure. As above, the temperature monitoring system 100 may include in a preferred embodiment, the plurality of display elements 150 include exactly two of the display elements in preferred embodiments. The plurality of display elements 150 may include two digital numerical displays. One of the two digital numerical displays may include a first-measurement of a first-temperature 200. A second of the two digital numerical displays may include a status of a battery of the temperature monitoring system 100. The first-temperature 200 includes a current temperature of the food supply unit 10. The temperature monitoring system is configured to send an alert to the user when a current-temperature of the food supply unit 10 falls below (or is above) the predetermined alert-temperature. The predetermined alert-temperature may comprise a range of temperature.

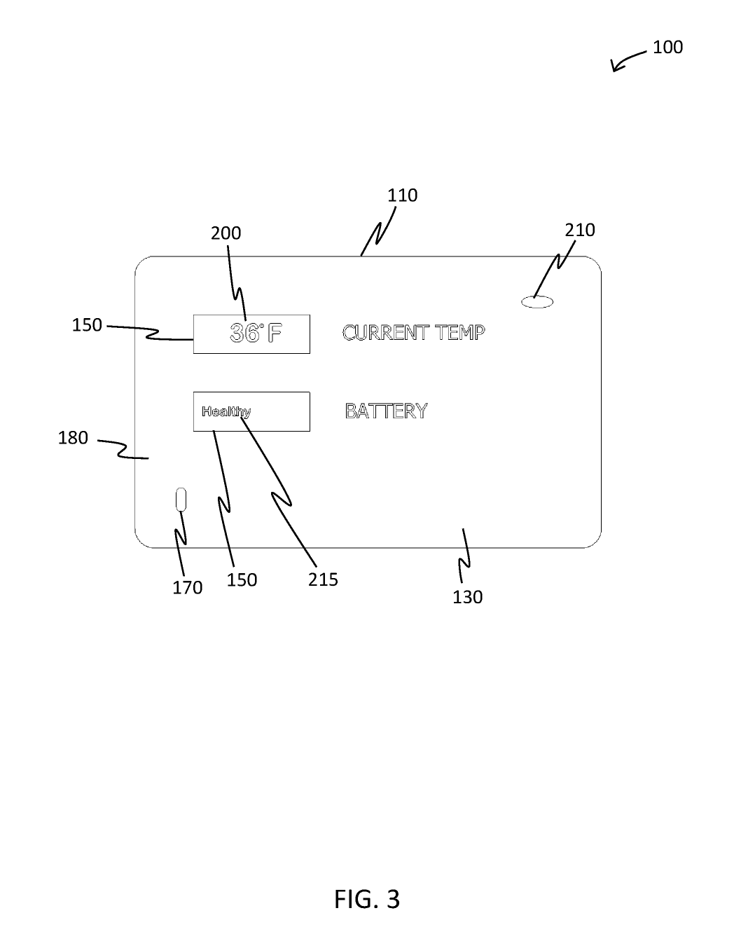

FIG. 3 shows a front view of the temperature monitoring system 100 of FIG. 1, according to an embodiment of the present disclosure. As above, the temperature monitoring system 100 may include the outer casing 110, the plurality of display elements 150, the plurality of buttons, the visual indicator 170, and the temperature sensing element 190. The temperature monitoring system 100 is configured to send an alert to the user when a current-temperature of the food supply unit 10 falls below the predetermined alert-temperature or rises above the predetermined alert temperature. The temperature monitoring system 100 further comprises a clip 250 for attaching the temperature monitoring system 100 to an outside of the food supply unit 10. The temperature monitoring system 100 further comprises a mounting bracket 240 for attaching the temperature monitoring system 100 to an outside of the food supply unit 10. The food supply unit 10 may be a freezer, a cooler, a refrigerator, a steam table, or other suitable food supply unit 10.

The temperature monitoring system 100 may include means to send alerts to a user when the current-temperature of the food supply unit 10 falls below the predetermined alert-temperature or rises above the predetermined alert temperature. The alert may be a digital communication 20 such as an email or app alert (if the app is downloaded). The visual indicator 170 is configured to indicate a Wi-Fi connection. The plurality of buttons includes a power indicator button 210, a temperature-up button, a temperature-down button, and other user operating buttons.

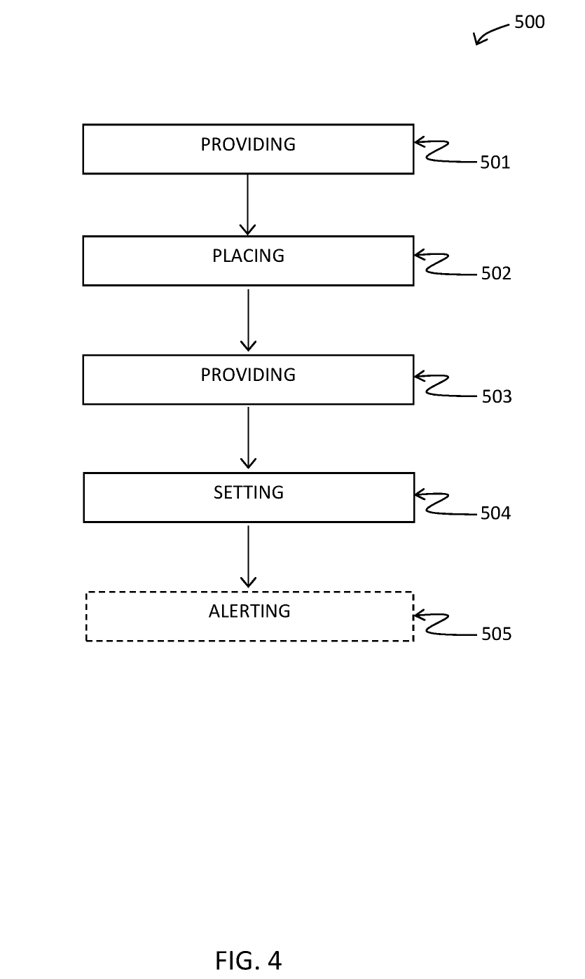

FIG. 4 is a flow diagram 550 illustrating a method of monitoring 500 an internal temperature of a food supply unit 100, according to an embodiment of the present disclosure. As illustrated, the method of monitoring 500 an internal temperature of a food supply unit 100 may include the steps of: step one 501, providing a temperature monitoring system 100 having an outer casing 110 having an elongate body 120 with a front side 130 and a back side 140, a plurality of display elements 150; the plurality of display elements 150 located on the front side 130 of the outer casing 110, a plurality of buttons; the plurality of buttons located on the front side 130 of the outer casing 110 and configured to allow manual control of the temperature monitoring system 100, a visual indicator 170; the visual indicator 170 located on an outermost portion 180 of the outer casing 110 and configured to communicate information to a user; a temperature sensing element 190, the temperature sensing element 190 coupled to the outer casing 110 and configured to sense the temperature inside the food supply unit 10; step two 502, placing the temperature monitoring system 100 on an outside of the food supply unit 10; step three 503, providing power to the temperature monitoring system 100 by manually pressing one of the plurality of buttons; step four 504, setting a threshold temperature for an inside of the food supply unit 10 by manually pressing a second of the plurality of buttons; and step five 505, alerting the user when the threshold temperature of the inside of the food supply unit 10 is reached. Alerting the user is by digital communication 20 selected from the group consisting of an email or app alert (if the app is downloaded). Other messaging means may be used.

It should be noted that step five 505 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for use, installation etc of temperature monitoring system 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A temperature monitoring system for continuously monitoring a temperature inside a food supply unit, said temperature monitoring system comprising:
an outer casing having an elongate body with a front side and a back side;
a plurality of display elements, said plurality of display elements located on said front side of said outer casing;
a button, said button located on said front side of said outer casing and configured to allow manual control of said temperature monitoring system;
a visual indicator, said visual indicator located on an outermost portion of said front side of said outer casing and configured to communicate information to a user;
a temperature sensing element, said temperature sensing element coupled to said outer casing and configured to sense a temperature inside a food supply unit; and
wherein said temperature monitoring system is configured to continuously monitor said temperature inside of said food supply unit.

2. The temperature monitoring system of claim 1, wherein said plurality of display elements include exactly two said display elements.

3. The temperature monitoring system of claim 1, wherein said plurality of display elements includes one digital numerical display and one word display.

4. The temperature monitoring system of claim 2, wherein one of said two display elements includes a first-measurement of a first-temperature.

5. The temperature monitoring system of claim 4, wherein a second of said two display elements includes a status of a battery of said temperature monitoring system.

6. The temperature monitoring system of claim 4, wherein said first-temperature includes a current temperature of said food supply unit.

7. The temperature monitoring system of claim 6, wherein said temperature monitoring system is configured to send an alert to said user when a current-temperature of said food supply unit falls below said predetermined alert-temperature.

8. The temperature monitoring system of claim 7, wherein said temperature monitoring system is configured to send said alert to said user when said current-temperature of said food supply unit rises above said predetermined alert temperature.

9. The temperature monitoring system of claim 1, further comprising a clip for attaching said temperature monitoring system to an outside of said food supply unit.

10. The temperature monitoring system of claim 1, further comprising a mounting bracket for attaching said temperature monitoring system to an outside of said food supply unit.

11. The temperature monitoring system of claim 1, wherein said food supply unit is selected from the group consisting of a freezer, a cooler, a refrigerator, and a steam table.

12. The temperature monitoring system of claim 9, wherein said alert is a digital communication.

13. The temperature monitoring system of claim 13, wherein said digital communication is selected from the group consisting of an email or app alert (if the app is downloaded).

14. The temperature monitoring system of claim 1, wherein said visual indicator is configured to indicate a Wi-Fi connection.

15. The temperature monitoring system of claim 1, wherein said button includes a power indicator button.

16. A temperature monitoring system for continuously monitoring a temperature inside a food supply unit, said temperature monitoring system comprising:
an outer casing having an elongate body with a front side and a back side;
a plurality of display elements, said plurality of display elements located on said front side of said outer casing;
a button, said button located on said front side of said outer casing and configured to allow manual control of said temperature monitoring system;
a visual indicator, said visual indicator located on an outermost portion of said front side of said outer casing and configured to communicate information to a user;
a temperature sensing element, said temperature sensing element coupled to said outer casing and configured to sense a temperature inside a food supply unit;
wherein said temperature monitoring system is configured to continuously monitor said temperature inside of said food supply unit;
wherein said plurality of display elements include exactly two said display elements;
wherein said plurality of display elements includes one digital numerical display and one word display;
wherein one of said two display elements includes a first-measurement of a first-temperature;
wherein a second of said two display elements includes a status of a battery of said temperature monitoring system;
wherein said first-temperature includes a current temperature of said food supply unit;
wherein said temperature monitoring system is configured to send an alert to said user when a current-temperature of said food supply unit falls below said predetermined alert-temperature;
wherein said temperature monitoring system is configured to send said alert to said user when said current-temperature of said food supply unit rises above said predetermined alert temperature;
further comprising a clip for attaching said temperature monitoring system to an outside of said food supply unit;
further comprising a mounting bracket for attaching said temperature monitoring system to an outside of said food supply unit;
wherein said food supply unit is selected from the group consisting of a freezer, a cooler, a refrigerator, and a steam table;
wherein said alert is a digital communication;
wherein said digital communication is selected from the group consisting of an email or app alert (if the app is downloaded);
wherein said visual indicator is configured to indicate a Wi-Fi connection;
wherein said button includes a power indicator button predetermined alert temperature;
wherein said temperature monitoring system is configured to send said alert to said user when said current temperature of said food supply unit rises above said predetermined alert temperature;
further comprising a clip for attaching said temperature monitoring system to an outside of said food supply unit;
wherein said alert is a digital communication;
wherein said visual indicator is configured to indicate a Wi-Fi connection; and
wherein said plurality of buttons includes a power indicator button, a temperature-up button, and a temperature-down button.

17. A method of monitoring an internal temperature of a food supply unit comprising:
providing a temperature monitoring system for continuously monitoring a temperature inside a food supply unit, said temperature monitoring system comprising:
an outer casing having an elongate body with a front side and a back side;
a plurality of display elements, said plurality of display elements located on said front side of said outer casing;
a button, said button located on said front side of said outer casing and configured to allow manual control of said temperature monitoring system;
a visual indicator, said visual indicator located on an outermost portion of said front side of said outer casing and configured to communicate information to a user;
a temperature sensing element, said temperature sensing element coupled to said outer casing and configured to sense a temperature inside a food supply unit; and
wherein said temperature monitoring system is configured to continuously monitor said temperature inside of said food supply unit;
placing said temperature monitoring system on an outside of said food supply unit;
providing power to said temperature monitoring system by manually pressing one of said plurality of buttons; and
setting a threshold temperature for an inside of said food supply unit by manually pressing a second of said plurality of buttons.

18. The method of claim 17, further comprising alerting said user when said threshold temperature of said inside of said food supply unit is reached.

19. The method of claim 19, wherein said alerting said user is by digital communication selected from the group consisting of an email or app alert (if the app is downloaded).
